(19) United States
(12) Patent Application Publication
(10) Pub. No.: US 2011/0146282 A1
(43) Pub. Date: Jun. 23, 2011

(54) SYSTEM AND METHOD FOR REDUCING SULFUR COMPOUNDS WITHIN FUEL STREAM FOR TURBOMACHINE

(75) Inventor: James Easel Roberts, Kansas City, MO (US)

(73) Assignee: GENERAL ELECTRIC COMPANY, Schenectady, NY (US)

(21) Appl. No.: 12/642,304

(22) Filed: Dec. 18, 2009

(51) Int. Cl. F01K 9/00; F02M 25/07; B01D 15/12

(52) U.S. Cl. 60/690; 60/694; 210/668

(57) ABSTRACT

A system and method for reducing sulfur compounds within a fuel stream for a turbomachine is presented. The system comprises: a turbomachine; a combustion system for burning a fuel including sulfur compounds, the burned fuel delivered to the turbomachine; and a sulfur compound reduction (SR) system positioned to reduce a level of the sulfur compounds in the fuel upstream of the combustion system.

### CROSS-REFERENCE TO RELATED APPLICATIONS

This invention is related to commonly-assigned U.S. patent application Ser. No. 11/928,038 [GE Docket 227348], filed Oct. 30, 2007; U.S. patent application Ser. No. 11/936,996 [GE Docket 228178], filed Nov. 8, 2007; and U.S. patent application Ser. No. 11/939,709 [GE Docket 229516], filed Nov. 14, 2007.

### BACKGROUND OF THE INVENTION

The invention relates generally to a system and method for reduction of compounds within a fuel stream for a turbomachine. More particularly, the invention relates to a system and a method for reducing harmful compounds, such as sulfur containing compounds, within the fuel stream entering the turbomachine.

There is interest over the long-term effects of carbon dioxide (CO₂) and sulfur oxides (SOₓ) emissions on the environment, and in particular, interest in emissions from a turbomachine.

### BRIEF DESCRIPTION OF THE INVENTION

A first aspect of the disclosure provides a system comprising: a turbomachine; a combustion system for burning a fuel including sulfur compounds, the burned fuel delivered to the turbomachine; and a sulfur compound reduction (SR) system positioned to reduce a level of the sulfur compounds in the fuel upstream of the combustion system.

A second aspect of the disclosure provides a method comprising: utilizing a sulfur compound reduction (SR) system to reduce sulfur compounds of a fuel entering a combustion system prior to burning the fuel; and burning the fuel and allowing the burned fuel having the sulfur compounds at a reduced level to exit the combustion system for delivery to the turbomachine.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic illustration of an embodiment of a system for reducing sulfur compounds within a fuel for a turbomachine, in accordance with the present invention;

FIG. 2 shows a schematic illustration of an embodiment of a system for reducing compounds of an exhaust of a turbomachine, in accordance with the present invention;

FIG. 3 shows a schematic illustration of another embodiment of a system for reducing compounds of an exhaust of a turbomachine, in accordance with the present invention;

FIG. 4 shows a schematic illustration of another embodiment of a system for reducing compounds of an exhaust of a turbomachine, in accordance with the present invention;

FIG. 5 shows a schematic illustration of another embodiment of a system for reducing compounds of an exhaust of a turbomachine, in accordance with the present invention; and

FIG. 6 shows a schematic illustration of another embodiment of a system for reducing compounds of an exhaust of a turbomachine, in accordance with the present invention.

### DETAILED DESCRIPTION OF THE INVENTION

Carbon dioxide (CO₂) gases may present a potentially harmful impact to the environment. As a result, emissions that may be emitted by a turbomachine, such as a gas turbine, are regulated. In addition because of the potential harmful nature of sulfur oxides (SOₓ) emissions in a recirculated exhaust to a turbomachine, emissions that may be recirculated in the turbomachine, such as a gas turbine, are closely monitored.

Exhaust gas recirculation (EGR) generally involves recirculating a portion of an emitted exhaust through an inlet portion of the turbomachine where it is mixing with the incoming airflow prior to combustion. This process may facilitate the removal and sequestration of concentrated CO₂, and the removal of SOₓ, thereby reducing the net emission levels.

Currently known EGR systems may not be entirely effective. Impurities and moisture within the exhaust gas prevent utilizing a simple recirculating loop to reduce CO₂ gasses and SOₓ emissions. Turbine fouling, corrosion, and accelerated wear of internal turbomachine components may result from introducing the exhaust gas directly to the turbomachine inlet portion. As a result, the diverted exhaust gas should be treated prior to blending with the inlet air. A significant amount of time, energy, and expense has been spent to develop EGR systems to prevent turbine fouling, corrosion, and accelerated wear of internal turbomachine components.

It has been discovered that an advantage that may be realized in the practice of some embodiments of a sulfur compound reduction (SR) system described herein is that the SR system may reduce and/or may eliminate sulfur compounds within a fuel for a turbomachine, and thus, resulting in the reduction and/or elimination of sulfur compounds present in an exhaust gas stream resulting from combustion of the fuel.

It has also been discovered that an advantage that may be realized in the practice of some embodiments of the SR system described herein is that the sulfur compound reduction and/or elimination within the fuel and the subsequent reduction and/or elimination of sulfur compounds in the exhaust gas stream may result in the reduction and/or elimination of sulfur compounds within the recirculated exhaust gas stream, and may minimize the corrosion and fouling of the internal components of the turbomachine, and allow for the design of simpler and more efficient EGR systems.

Certain terminology is used herein for the convenience of the reader only and is not to be taken as a limitation on the scope of the invention. For example, words such as “upper,” “lower,” “left,” “right,” “front”, “rear” “top”, “bottom”, “horizontal,” “vertical,” “upstream,” “downstream,” “fore”, “aft”, and the like are merely meant to describe the configuration shown in the figures. Indeed, the element or elements of an embodiment of the present invention may be oriented in any direction and the terminology, therefore, should be understood as encompassing such variations unless specified otherwise.

The SR system of an embodiment of the present invention may comprise multiple components. The configuration and sequence of the components may be dictated by the composition of the fuel for the turbomachine. In an embodiment, the steps comprising the SR process are: utilizing the SR system to reduce the sulfur compounds of a fuel prior to burning the fuel; and allowing the fuel having the sulfur compounds at a reduced level to exit the SR system to the combustion system of the turbomachine.

In an embodiment, the present invention may have the technical effect of reducing and/or eliminating the levels of sulfur compounds within a fuel for a turbomachine prior to combustion of the fuel.

In another embodiment, the present invention may have the technical effect of reducing and/or eliminating the levels of sulfur compounds that may be present in an exhaust gas stream of a turbomachine.

In another embodiment, the present invention may have the technical effect of reducing and/or eliminating levels of sulfur compounds that may be present in an exhaust gas stream for recirculation by an exhaust gas recirculation system.

The SR system may be applied to a variety of turbomachines that produce a gaseous fluid, including but not limited to, a heavy duty gas turbine; an aero-derivative gas turbine; or the like (hereinafter referred to as “gas turbine”). An embodiment of the present invention may be applied to either a single gas turbine or a plurality of gas turbines. Another embodiment of the present invention may be applied to a gas turbine operating in a simple cycle or a combined cycle configuration.

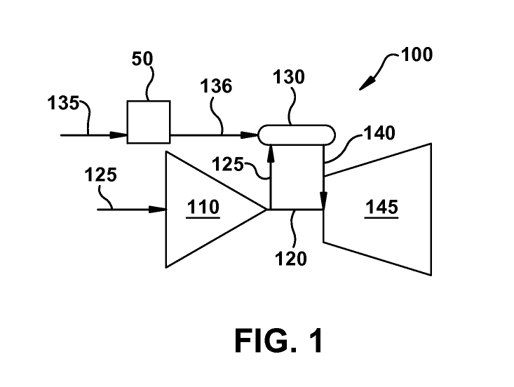

Referring to FIG. 1, a schematic illustration of an embodiment of a system for reducing sulfur compounds within a fuel for a turbomachine is shown. FIG. 1 illustrates a gas turbine 100 and a sulfur compound reduction (SR) system 50.

In an embodiment, gas turbine 100 may comprise a compressor 110 having a shaft 120. Air 125 may enter the inlet of compressor 110, may be compressed by compressor 110, and may then be discharged to a combustion system 130, where a fuel 136, including but not limited to natural gas, may be burned to provide high-energy combustion gases 140 which drive a turbine 145. In turbine 145, the energy of the hot gases 140 may be converted into work, some of which may be used to drive compressor 110 through shaft 120, with the remainder being available for useful work to drive a load (not illustrated).

In an embodiment, SR system 50 may comprise at least one component selected from the group consisting of a pressure swing adsorption unit, an iron sponge, a carbon adsorption bed, a Rectisol wash unit, and a triazine based sulfur compound scavenging unit. The aforementioned components are known in the art and thus, for the sake of clarity, no further description is provided. Additionally, the process and operation by which the aforementioned components reduce sulfur compounds is well known in the art and would be recognized by one having ordinary skill in the art and thus, for the sake of clarity, no further description is provided. In another embodiment, any means or process currently existing for reducing sulfur compounds within a fuel but not stated herein, or any means or process for reducing sulfur compounds within a fuel developed in the future that may be operatively integrated with a turbomachine, and in particular, a combustion system of the turbomachine, by one having ordinary skill in the art is encompassed by the system of the present invention.

In an embodiment, SR system 50 may additionally comprise a fuel line, not shown, that integrates SR system 50 with combustion system 130, so as to allow combustion system 130 to receive fuel 136 exiting SR system 50. One having ordinary skill in the art will recognize how SR system 50 may be operatively integrated with combustion system 130, via a fuel line or any other mechanism, and for the sake of clarity, no further discussion is provided.

SR system 50 may receive fuel 135 having sulfur compounds. The components of SR system 50 described herein may reduce the level of sulfur compounds present in fuel 135. Afterward, fuel 136 having a reduced level of sulfur compounds then may exit SR system 50 to combustion system 130 for combustion. In an embodiment, SR system 50 may be positioned upstream of combustion system 130. In an embodiment, the reduction of sulfur compounds may comprise reducing a level at a range of approximately 10 parts per million by weight to approximately 100 parts per billion (ppb) by weight and all subranges therebetween to a level at a range from approximately 0.0 ppb by weight to approximately 20 ppb by weight and all subranges therebetween.

In an embodiment, fuel 135 may comprise at least one sulfur compound selected from the group consisting of a sulfide, a mercaptan, a thiol, and combinations thereof. In another embodiment, fuel 135 may comprise at least one sulfur compound selected from the group consisting of hydrogen sulfide, methyl ethyl sulfide, t-butyl mercaptan, ethyl mercaptan, methyl mercaptan, and combinations thereof. In an embodiment, SR system 50 may be of a size and fabricated of a material capable of withstanding the physical properties, including but not limited to a fuel 135 and a fuel 136 flow rate of approximately 20,000 pounds per hour (lb/hr) to approximately 60,000 lb/hr.

In another embodiment of the present invention, the system for reducing sulfur compounds within a fuel of the turbomachine described herein may be used for multiple SR systems, multiple fuels, and multiple turbomachines. In an embodiment of the present invention, the system for reducing sulfur compounds within a fuel of the turbomachine described herein may comprise: at least one turbomachine; at least one combustion system for burning at least one fuel including, sulfur compounds, the at least burned fuel delivered to the at least one turbomachine; and an at least one sulfur compound reduction (SR) system positioned to reduce a level of the sulfur compounds in the at least one fuel upstream of the at least one combustion system.

In an embodiment of the present invention, a method of reducing sulfur compounds within a fuel of a turbomachine is presented. The method comprises: utilizing a sulfur compound reduction (SR) system to reduce sulfur compounds of a fuel entering a combustion system prior to burning the fuel; and burning the fuel and allowing the burned fuel having the sulfur compounds at a reduced level to exit the combustion system for delivery to the turbomachine.

Referring to aspects of FIG. 1, an embodiment of the method of reducing sulfur compounds within a fuel of a turbomachine is described herein. A SR system 50 may be provided and may be operatively integrated with combustion system 130. Various characteristics and embodiments of SR system 50 have been described herein and thus, for the sake of clarity, no further discussion is provided. A fuel 135 having sulfur compounds is established with a SR system 50. SR system 50 may then reduce the sulfur compounds of fuel stream 135 prior to burning. Various embodiment of how SR system 50 may reduce the sulfur compounds of fuel 135 have been described herein and thus, for the sake of clarity, no further description if provided. Fuel 136 having sulfur compounds at a reduced level then exits SR system 50 to combustion system 130 for combustion. Fuel 136 then may be burned and the burned fuel delivered to gas turbine 100.

In another embodiment of the present invention, the method of reducing sulfur compounds within a fuel of a turbomachine described herein may be used for multiple SR systems, multiple fuels, and multiple turbomachines. In an embodiment of the present invention, method of reducing sulfur compounds within a fuel of a turbomachine described herein may comprise: utilizing at least one sulfur compound reduction (SR) system to reduce sulfur compounds of at least one fuel entering at least one combustion system prior to burning the at least one fuel; and burning the at least one fuel and allowing the burned fuel having the sulfur compounds at a reduced level to exit the at least one combustion system for delivery to the at least one turbomachine.

In an embodiment of the present invention, a system that may reduce sulfur compounds within a fuel of a turbomachine, may reduce compounds of an exhaust stream the turbomachine, and may recirculate a portion of the exhaust stream of the turbomachine where the exhaust stream may be mixed with the inlet air and re-enter the turbomachine without affecting reliability and availability of the unit is presented. The system may comprise a sulfur compound reduction (SR) system and an exhaust gas recirculation (EGR) system. Characteristics, various embodiments, and methods of use of the SR system are described herein, and thus, for the sake of clarity, no further discussion is provided.

Generally, an EGR system receives a portion of the exhaust, hereinafter referred to as exhaust stream, from a turbomachine, reduces the level of compounds within the exhaust stream, and then recirculates the exhaust stream to an inlet section of the turbomachine. This process facilitates a reduction in level of emissions within the exhaust stream and allows for the removal and/or sequestration of compounds.

The EGR system of an embodiment of the present invention may comprise multiple elements. The configuration and sequence of the elements may be dictated by the composition of the exhaust gas. In general, the steps comprising the exhaust gas re-circulation process may be: cooling, scrubbing, de-misting, high efficiency particulate and droplet removal, and mixing. When the present invention is utilized, the diverted gas, blended with inlet air, may be introduced to the turbine inlet without harm. As described herein, there are multiple arrangements that may be used to accomplish the exhaust gas treatment.

In an embodiment of the EGR system, the present invention has the technical effect of reducing the levels of concentrated CO₂ and harmful compounds, such as SOₓ, all of which may be within a portion of the exhaust (hereinafter “exhaust stream”, or the like). The levels may be reduced from a first level to a second level that may be determined by an operator of the turbomachine. An embodiment of the present invention may also allow for the removal and sequestration of concentrated CO₂ emissions.

The EGR system may be applied to the variety of turbomachines that produce a gaseous fluid, including but not limiting to, a heavy duty gas turbine; an aero-derivative gas turbine; or the like (hereinafter referred to as “gas turbine”). An embodiment of the present invention may be applied to either a single gas turbine or a plurality of gas turbines. An embodiment of the present invention may be applied to a gas turbine operating in a simple cycle or a combined cycle configuration.

As described herein, an embodiment of the EGR system may utilize at least one scrubber; or at least one scrubber and at least one downstream heat exchanger; or at least one scrubber and at least one upstream heat exchanger; or at least one scrubber, at least one downstream heat exchanger, and at least one upstream heat exchanger; or various combinations thereof. Moreover, each and any of the aforementioned embodiments may include an injector that may introduce a reagent for reducing the level of harmful constituents within the exhaust stream, and a wet electrostatic precipitator for removing the constituents.

In an embodiment of the present invention, the elements, including but not limited to a scrubber and a heat exchanger, may be fabricated of any materials that can withstand the operating environment under which the EGR system may function and operate.

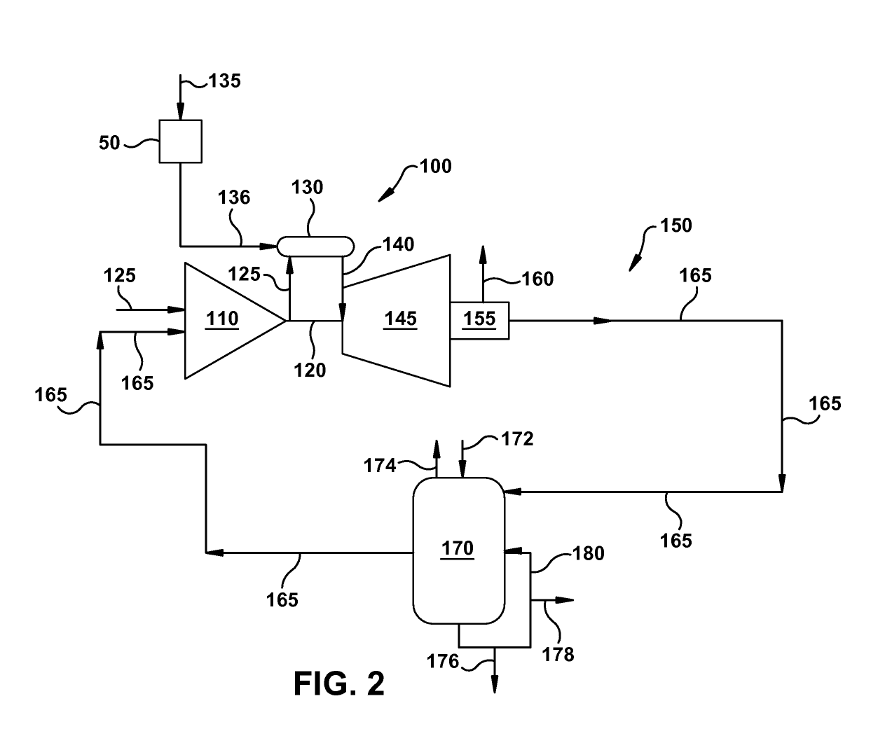

Referring to FIG. 2, a schematic illustration of an embodiment of a system for reducing compounds of an exhaust of a turbomachine is shown. The system comprises a gas turbine 100, a combustion system 130, and a sulfur compound reduction (SR) system 50. In an embodiment, the system may additionally comprise an exhaust gas recirculation (EGR) system 150.

In an embodiment, SCR system 50 may reduce sulfur compounds at a within a fuel stream 135. Fuel stream 136 having sulfur compounds at a reduced level may then exit SR system 50 to combustion system 130 of gas turbine 100 for combustion. Characteristics, various embodiments, and methods of use of SR system 50 are described herein, and thus, for the sake of clarity, no further discussion is provided. Characteristics and various embodiments of use of gas turbine 100 are described herein, and thus, for the sake of clarity, no further discussion is provided.

In an embodiment, EGR system 150 may comprise at least one EGR flow modulation device 155 and at least one scrubber 170. At least one EGR flow modulation device 155 may apportion the total exhaust flow (not illustrated in FIG. 2) between a non-recirculated exhaust 160 and at least one exhaust stream 165. At least one EGR flow modulation device 155 may be of a size and fabricated of a material capable of withstanding the physical properties, including but not limited to, a flow rate of approximately 10,000 pounds per hour (lb/hr) to approximately 50,000,000 lb/hr and a temperature of approximately 38° C. to approximately 816° C.

An operator of gas turbine 100 may determine the position of at least one EGR flow modulation device 155 based on the desired flow rate of at least one exhaust stream 165. At least one exhaust stream 165 may flow downstream of at least one EGR flow modulation device 155 to an inlet portion of at least one scrubber 170.

In an embodiment, a scrubber system (hereinafter “scrubber”) is generally considered as an air pollution control device that may remove particulates and/or other emissions from industrial exhaust streams. A scrubber may use a “scrubbing process”, or the like, involving a liquid to “scrub” unwanted pollutants from a gas stream.

In an embodiment, at least one scrubber 170 may perform a variety of functions after receiving at least one exhaust stream 165. At least one scrubber 170 may lower the temperature of at least one exhaust stream 165 to a range of approximately 16° C. to approximately 38° C. At least one scrubber 170 may also remove a portion of the plurality of constituents (not illustrated) within at least one exhaust stream 165, from a first level to a second level. In an embodiment, an operator of at least one turbomachine may determine requirements of the second level. The compounds may include for example, at least one of: water vapor, acids, aldehydes, hydrocarbons, and combinations thereof.

At least one scrubber 170 may receive and then later discharge a scrubber cooling fluid 172, 174; which may be of a type that allows for the heat transfer required to lower the temperature of at least one exhaust stream 165, as described herein. At least one scrubber 170 may also include at least one scrubber blow down line 176; which may remove the portion of the aforementioned compounds and concentrated CO₂. Condensable line 178 may remove the portions of at least one exhaust stream 165 that may condense during the scrubbing process. Scrubber recirculation line 180 may recirculate a portion of at least one exhaust stream 165 to increase the effectiveness of the scrubbing process. After the scrubbing process, at least one exhaust stream 165 may flow downstream to compressor 110. EGR system 150 may then mix inlet air 125 with at least one exhaust stream 165, prior to the compression performed by compressor 110.

In use, SCR system 50 and EGR system 150 of an embodiment of the present invention may function while gas turbine 100 is in operation. EGR flow modulation device 155 may be positioned to allow for the desired flow rate of at least one exhaust stream 165, and non-recirculated exhaust 160 may flow through an exhaust stack (not illustrated), or the like or elsewhere, including but not limited to, a heat recovery steam generator (not illustrated). At least one exhaust stream 165 may then flow downstream through at least one scrubber 170, as described herein.

In at least one scrubber 170, the temperature of at least one exhaust stream 165 may be lowered to below the saturation temperature. The use of scrubber cooling fluid 172, 174 and the drop in temperature of at least one exhaust stream 165 may cause a portion of at least one exhaust stream 165 to flow through the scrubber recirculation line 180. In an embodiment, a portion of condensable vapors of at least one exhaust stream 165 may be removed via condensable line 178. Then, at least one exhaust stream 165 may flow downstream of at least one scrubber 170 and into compressor 110.

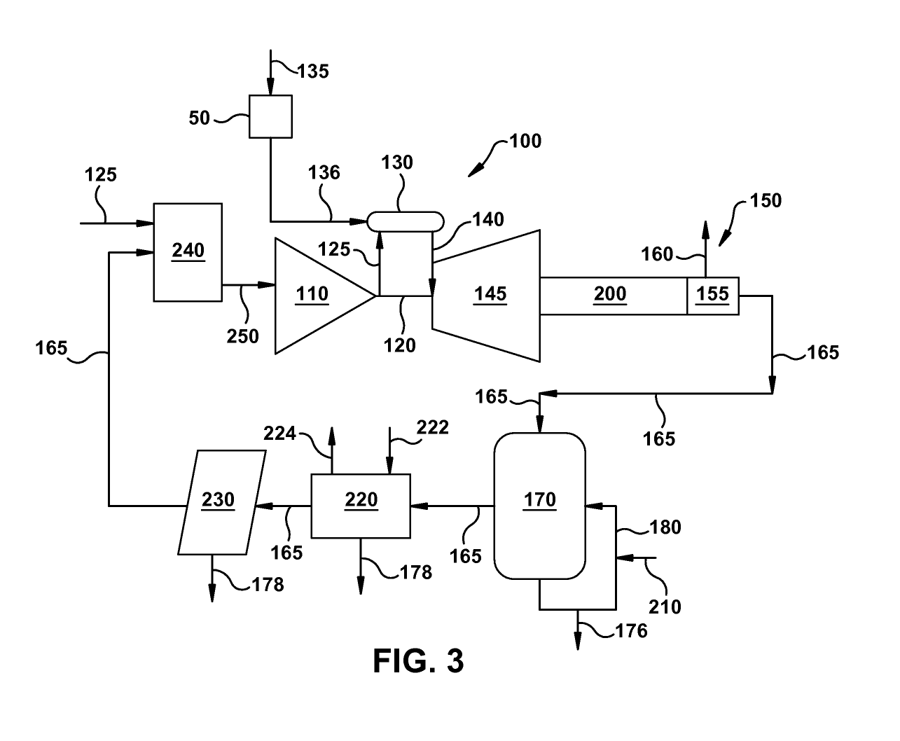

Alternate embodiments of the present invention described herein and illustrated in FIGS. 3 through 6, may modify the flow path of at least one exhaust stream 165 and the configuration of EGR system 150. Furthermore, FIGS. 3 through 6 illustrate an embodiment in which at least one gas turbine 100 may be configured for a combined cycle operation. In an embodiment, a heat recovery steam generator (HRSG) 200 may receive the total exhaust of gas turbine 100. As illustrated in FIGS. 3 through 6, EGR flow modulation device 155 may be connected downstream of HRSG 200 and function as described herein.

Referring to FIG. 3, a schematic illustration of an embodiment of a system for reducing compounds of an exhaust of a turbomachine is shown. The system comprises a gas turbine 100, a combustion system 130, and a sulfur compound reduction (SR) system 50. In an embodiment, the system may additionally comprise an exhaust gas recirculation (EGR) system 150.

In an embodiment, SCR system 50 may reduce sulfur compounds within a fuel 135. Fuel 136 having sulfur compounds at a reduced level then may exit SR system 50 to combustion system 130 of gas turbine 100 for combustion. Characteristics, various embodiments, and methods of use of SR system 50 are described herein, and thus, for the sake of clarity, no further discussion is provided. Characteristics and various embodiments of use of gas turbine 100 are described herein, and thus, for the sake of clarity, no further discussion is provided. In an embodiment of the present invention, EGR system 150 may include: at least one scrubber 170, at least one downstream heat exchanger 220; at least one de-mister 230; and at least one mixing station 240.

In an embodiment, at least one scrubber 170 may reduce the temperature of at least one exhaust stream 165 and may also remove a portion of the plurality of constituents (not illustrated) within at least one exhaust stream 165, as described herein. At least one scrubber 170 may include at least one scrubber blow down line 176 and at least one scrubber recirculation line 180, as described herein. At least one scrubber 170 may also include at least one scrubber make-up line 210 which may supply a fluid used in the scrubbing process.

At least one downstream heat exchanger 220 may be located downstream of at least one scrubber 170 and may cool at least one exhaust stream 165 down to a reasonable temperature such that the performance of gas turbine 100 may not be impacted due to a hot inlet air 130 temperature. In an embodiment, at least one downstream heat exchanger 220 may reduce the temperature of at least one exhaust stream 165 to a range of approximately 2° C. (roughly above a freezing temperature) to approximately 38° C.

At least one downstream heat exchanger 220 may receive and then later discharge a downstream cooling fluid 222, 224; which may be of a type that allows for the amount of heat transfer required to lower the temperature of at least one exhaust stream 165, as described herein. At least one downstream heat exchanger 220 may also include at least one condensable line 178, which may remove the portions of at least one exhaust stream 165 that may condense during the heat exchanging process.

At least one de-mister 230 may be located downstream of at least one downstream heat exchanger 220 in an embodiment of the present invention. At least one de-mister 230 may remove droplets of water from at least one exhaust stream 165 that may have carried from the scrubbing and the heat exchanging processes.

As described herein, an embodiment of the present invention may include at least one mixing station 240, which may be located downstream of at least one downstream heat exchanger 220. At least one mixing station 240 may be considered a device which mixes inlet air 125 and at least one exhaust stream 165, and forms an inlet fluid 250 that enters compressor 240. At least one mixing station 240 may utilize, for example, baffles, flow turners, or the like, to mix inlet air 125 with at least one exhaust stream 165. In another embodiment, at least one mixing station 240 may not be required. For example, inlet air 125 and at least one exhaust stream 165 may mix within an area adjacent to compressor 110, including but not limited to an inlet duct, in the plenum, near the inlet filter house, or the like.

In use, SR system 50 and EGR system 150 of an embodiment of the present invention may function while gas turbine 100 is in operation. EGR flow modulation device 155 may be positioned to allow for the desired flow rate of at least one exhaust stream 165, as described herein. At least one exhaust stream 165 may then flow downstream through at least one scrubber 170, as described herein. In at least one scrubber 170, the temperature of at least one exhaust stream 165 may be lowered to below the saturation temperature. The use of scrubber cooling fluid 172, 174 and the drop in temperature of at least one exhaust stream 165 may cause a portion of stream 165 to flow through scrubber recirculation line 180. A portion of the fluid used within scrubber 170 may be replaced with fresh fluid via a scrubber make-up line 210.

In an embodiment, at least one exhaust stream 165 may flow downstream of at least one scrubber 170 to at least one downstream heat exchanger 220, where a portion of condensable vapors of at least one exhaust stream 165 may be removed via condensable line 178. Then, at least one exhaust stream 165 may flow through at least one de-mister 230 and then into at least one mixing station 240, all of which are described herein. Downstream of at least one mixing station 240, inlet fluid 250 may flow into compressor 110. In an embodiment, at least one de-mister 230 and at least one mixing station 240 may have an alternate configuration. For example, EGR system 150 may be configured such that at least one mixing station 240 is located immediately downstream of at least one downstream heat exchanger 220; and therefore at least one de-mister 230 may be located downstream of at least one mixing station 240.

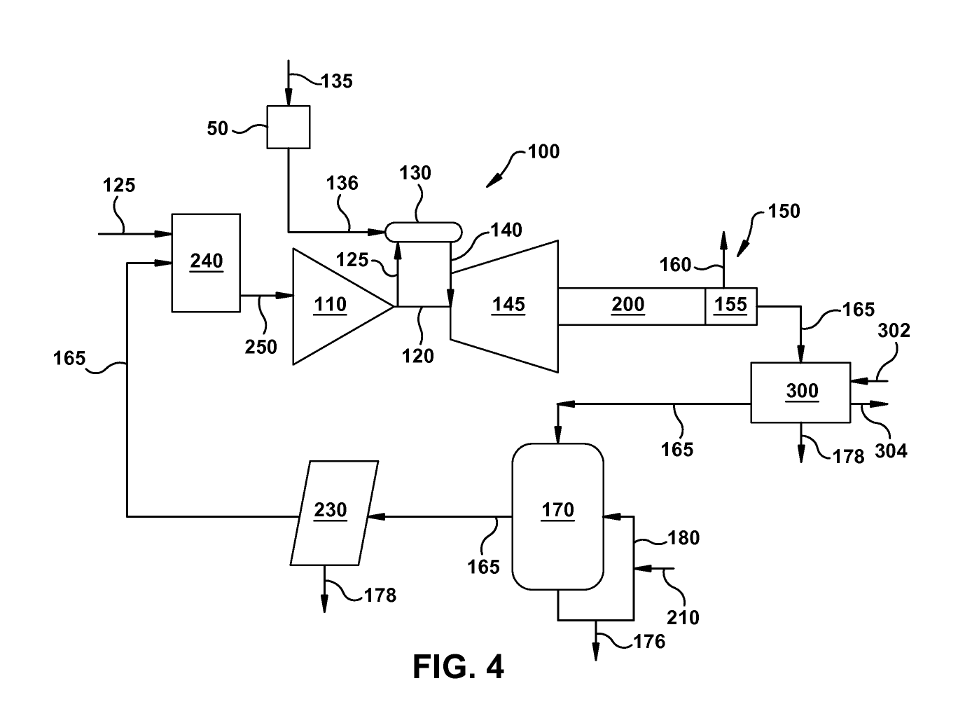

Referring to FIG. 4, a schematic illustration of an embodiment of a system for reducing compounds of an exhaust of a turbomachine is shown. The system comprises a gas turbine 100, a combustion system 130, and a sulfur compound reduction (SR) system 50. In an embodiment, the system may additionally comprise an exhaust gas recirculation (EGR) system 150.

In an embodiment, SR system 50 may reduce sulfur compounds within a fuel stream 135. Fuel stream 136 having sulfur compounds at a reduced level then may exit SR system 50 to combustion system 130 of gas turbine 100 for combustion. Characteristics, various embodiments, and methods of use of the SR system are described herein, and thus, for the sake of clarity, no further discussion is provided. Characteristics and various embodiments of use of gas turbine 100 are described herein, and thus, for the sake of clarity, no further discussion is provided. In an embodiment of the present invention, EGR system 150 may include: at least one scrubber 170, at least one downstream heat exchanger 220; at least one de-mister 230; and at least one mixing station 240.

In an embodiment of the present invention, at least one upstream heat exchanger 300 may be located upstream of at least one scrubber 170. In an embodiment, EGR system 150 may include: at least one scrubber 170, at least one upstream heat exchanger 300; at least one de-mister 230; and at least one mixing station 240. At least one upstream heat exchanger 300 may be located upstream of the at least one scrubber 170, and may receive at least one exhaust stream 165 exiting EGR flow modulation device 155. At least one upstream heat exchanger 300 may cool at least one exhaust stream 165 to a range of approximately 16° C. to approximately 38° C.

At least one upstream heat exchanger 300 may receive and then later discharge a upstream cooling fluid 302, 304; which may be of a type that allows for the amount of heat transfer required to lower the temperature of at least one exhaust stream 165, as described herein. At least one upstream heat exchanger 300 may also include at least one condensable line 178, which may remove portions of at least one exhaust stream 165 that may condense during the heat exchanging process.

In use, EGR system 150 of an embodiment of the present invention functions while gas turbine 100 is in operation. EGR flow modulation device 155 may be positioned to allow for the desired flow rate of at least one exhaust stream 165, as described herein. At least one exhaust stream 165 may then flow downstream through at least one upstream heat exchanger 300, where a portion of condensable vapors of at least one exhaust stream 165 may be removed via condensable line 178.

In an embodiment, at least one exhaust stream 165 may flow downstream through at least one scrubber 170, as described herein. Then, at least one exhaust stream 165 may flow downstream of at least one scrubber 170 to at least one de-mister 230, and then into at least one mixing station 240, all of which are described herein. Downstream of at least one mixing station 240, inlet fluid 250 may flow into compressor 110. In an embodiment, EGR system 150 may be configured such that at least one mixing station 240 may be located immediately downstream of at least one downstream heat exchanger 220; and therefore at least one de-mister 230 may be located downstream of at least one mixing station 240.

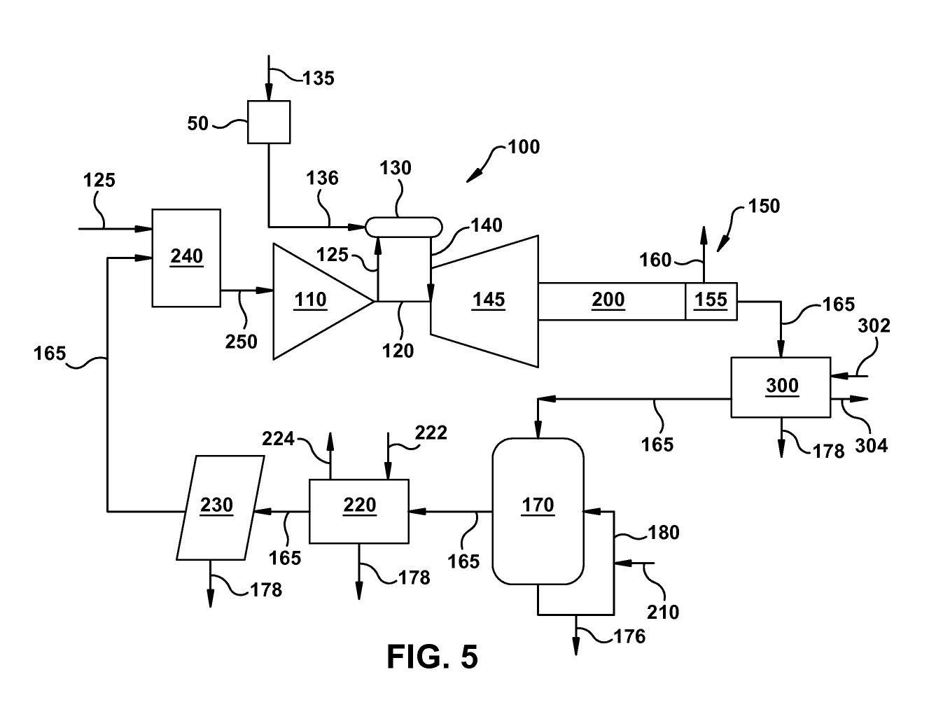

Referring to FIG. 5, a schematic illustration of an embodiment of a system for reducing compounds of an exhaust of a turbomachine is shown. The system comprises a turbine 100, a combustion system 130, and a sulfur compound reduction (SCR) system 50. In an embodiment, the system may additionally comprise an exhaust gas recirculation (EGR) system 150.

In an embodiment, SR system 50 may reduce sulfur compounds within a fuel stream 135. Fuel stream 136 having sulfur compounds at a reduced level then may exit SR system 50 to combustion system 130 of gas turbine 100 for combustion. Characteristics, various embodiments, and methods of use of SR system 50 are described herein, and thus, for the sake of clarity, no further discussion is provided. Characteristics and various embodiments of use of gas turbine 100 are described herein, and thus, for the sake of clarity, no further discussion is provided. In an embodiment of the present invention, EGR system 150 may include: at least one scrubber 170, at least one downstream heat exchanger 220; at least one de-mister 230; and at least one mixing station 240.

In an embodiment of the present invention, heat may be removed from at least one exhaust stream 165, which may be accomplished by multiple heat exchangers located up and down stream of at least one scrubber 170. In an embodiment, this configuration may allow for relatively smaller heat exchangers than those described herein. In an embodiment, both at least one downstream heat exchanger 220 and at least one upstream heat exchanger 300 may be included within EGR system 150. In an embodiment, EGR system 150 may include: at least one scrubber 170, at least one upstream heat exchanger 300; at least one downstream heat exchanger 220; at least one de-mister 230; and at least one mixing station 240.

In an embodiment, the operation of at least one upstream heat exchanger 300, at least one downstream heat exchanger 220, and at least one scrubber 170 may be integrated to remove heat from, and thus lower the temperature of at least one exhaust stream 165 in stages, as described herein.

In use, SR system 50 and EGR system 150 of an embodiment of the present invention may function while gas turbine 100 is in operation. EGR flow modulation device 155 may be positioned to allow for the desired flow rate of at least one exhaust stream 165, as described herein. At least one exhaust stream 165 may then flow downstream through at least one upstream heat exchanger 300, which may lower the temperature of at least one exhaust stream 165 to a range of approximately 49° C. to approximately 66° C.

In an embodiment, at least one exhaust stream 165 may then flow downstream to at least one scrubber 170, as described herein. Then, at least one exhaust stream 165 may flow downstream of at least one scrubber 170 through at least one downstream heat exchanger 220, which may lower the temperature of at least one exhaust stream 165 to a range of approximately 16° C. to approximately 38° C. Then, at least one exhaust stream 165 may flow through at least one de-mister 230 and then into at least one mixing station 240, all of which are described herein. Downstream of at least one mixing station 240, inlet fluid 250 may flow into compressor 110.

An embodiment of the present invention may also allow for an alternate staging of the heat removal from at least one exhaust stream 165. For example, at least one upstream heat exchanger 300 may lower the temperature of at least one exhaust stream 165 to a range of approximately 66° C. to approximately 177° C.; then at least one scrubber 170 may lower the temperature to a range of approximately 49° C. to approximately 66° C.; and then at least one downstream heat exchanger 220 may lower the temperature to a range of approximately 16° C. to approximately 38° C.

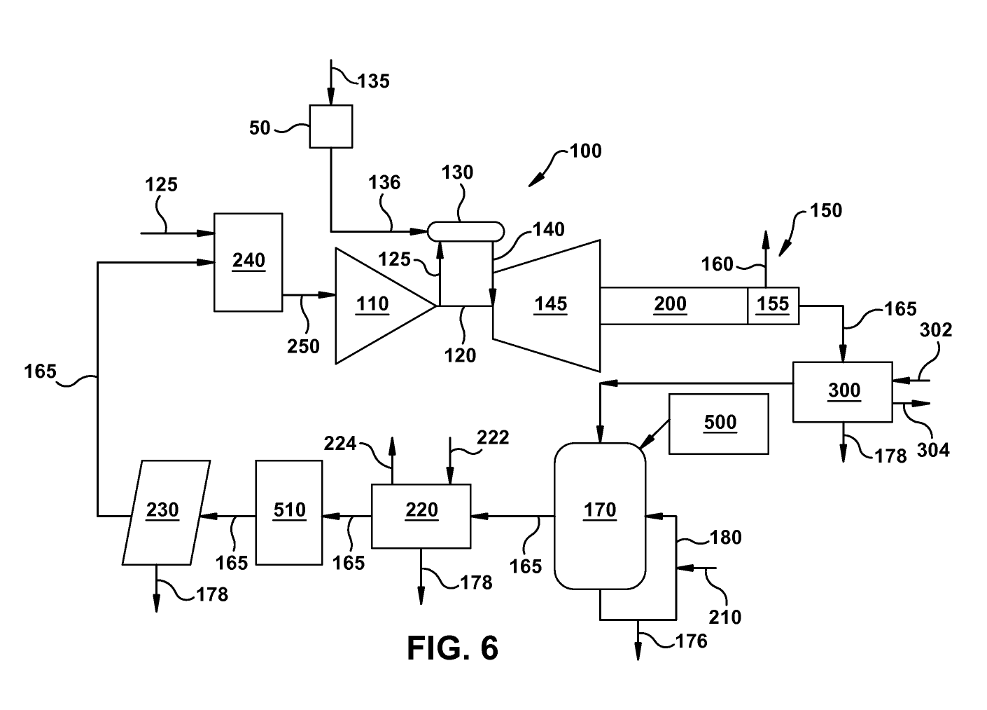

Referring to FIG. 6, a schematic illustration of an embodiment of a system for reducing compounds of an exhaust of a turbomachine is shown. The system comprises a gas turbine 100, a combustion system 130, and a sulfur compound reduction (SR) system 50. In an embodiment, the system may additionally comprise an exhaust gas recirculation (EGR) system 150.

In an embodiment, SR system 50 may reduce sulfur compounds within fuel stream 135. Fuel stream 136 having sulfur compounds at a reduced level then may exit SR system 50 to combustion system 130 of gas turbine 100 for combustion. Characteristics, various embodiments, and methods of use of SR system 50 are described herein, and thus, for the sake of clarity, no further discussion is provided. Characteristics and various embodiments of use of gas turbine 100 are described herein, and thus, for the sake of clarity, no further discussion is provided. In an embodiment of the present invention, EGR system 150 may include: at least one scrubber 170, at least one downstream heat exchanger 220; at least one de-mister 230; and at least one mixing station 240.

In an embodiment of the present invention, at least one injector 500 and at least one wet electrostatic precipitator 510 is included in EGR system 150. As described herein, at least one scrubber 170 may use a fluid in scrubbing process to remove a portion of the constituents within at least one exhaust stream 165. In an embodiment, a reagent may be required to assist in the removal of the constituents due to their make up. The reagent may perform an absorption process to remove the constituents. The reagent may include for example, an ammonia, a limestone based liquid reagent, water, or the like, and combinations thereof. At least one injector 500 may inject the reagent into at least one scrubber 170 of EGR system 150.

The absorption process used by the reagent may create a particulate matter that may be removed from at least one scrubber 170. At least one wet electrostatic precipitator 510 may remove the particulate matter. Generally the wet electrostatic precipitator 510 may induce an electrostatic charge and utilize a fluid to perform a scrubbing like action, in removing particulate matter from at least one scrubber 170.

At least one injector 500 and at least one wet electrostatic precipitator 510 may be added to any of the previous embodiments described herein. As described herein, at least one injector 500 and at least one wet electrostatic precipitator 510 may be utilized when the condensing and scrubbing processes described herein do not reduce the constituents within at least one exhaust stream 165 to the second level.

In an embodiment of the present invention, EGR system 150 may include: at least one scrubber 170; at least one injector 500; at least one upstream heat exchanger 300; at least one downstream heat exchanger 220; at least one wet electrostatic precipitator 510; at least one de-mister 230; and at least one mixing station 240.

In use, SR system 50 and EGR system 150 of an embodiment of the present invention may function while gas turbine 100 is in operation. EGR flow modulation device 155 may be positioned to allow for the desired flow rate of at least one exhaust stream 165, as described herein. At least one exhaust stream 165 may flow downstream through at least one upstream heat exchanger 300, which may lower the temperature of at least one exhaust stream 165 to a range of approximately 49° C. to approximately 66° C. Then, at least one exhaust stream 165 may then flow downstream to at least one scrubber 170, where at least one injector 500 may inject at least one reagent, as described herein.

Then, at least one exhaust stream 165 may flow downstream of at least one scrubber 170 through at least one downstream heat exchanger 220, which may lower the temperature of at least one exhaust stream 165 to a range of approximately 16° C. to approximately 38° C. Then, at least one exhaust stream 165 may flow through at least one wet electrostatic precipitator 510, then into at least one de-mister 230, and then into at least one mixing station 240, all of which are described herein. Downstream of at least one mixing station 240, inlet fluid 250 may flow into compressor 110.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “approximately” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to approximately 25 wt %, or, more specifically, approximately 5 wt % to approximately 20 wt %”, is inclusive of the endpoints and all intermediate values of the ranges of “approximately 5 wt % to approximately 25 wt %,” etc).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system comprising:
a turbomachine;
a combustion system for burning a fuel including sulfur compounds, the burned fuel delivered to the turbomachine; and
a sulfur compound reduction (SR) system positioned to reduce a level of the sulfur compounds in the fuel upstream of the combustion system.

2. A system according to claim 1, wherein the SR system comprises at least one component selected from the group consisting of pressure swing adsorption unit, an iron sponge, a carbon adsorption bed, and a triazine based sulfur compound scavenging unit.

3. A system according to claim 1, wherein the sulfur compounds comprise at least one compound selected from the group consisting of a sulfide, a mercaptan, a thiol, and combinations thereof.

4. A system according to claim 3, wherein the sulfur compounds comprise at least one compound selected from the group consisting of hydrogen sulfide, methyl ethyl sulfide, t-butyl mercaptan, ethyl mercaptan, methyl mercaptan, and combinations thereof.

5. A system according to claim 1, wherein the SR system additionally comprises a fuel line, wherein the fuel line integrates the SR system with the combustion system, allowing for the combustion system to receive the fuel exiting the SR system.

6. A system according to claim 1, additionally comprising an exhaust gas recirculation system (EGR) comprising at least one scrubber coupled to an exhaust stream of the turbomachine.

7. A system according to claim 6, wherein the scrubber:
receives the exhaust stream comprising compounds at a first level;
reduces the compounds to a second level; and
allows the exhaust stream to exit at a second temperature; and
wherein the exhaust stream is a portion of a total exhaust exiting the turbomachine; and wherein the EGR system recirculates the exhaust stream exiting the scrubber to an inlet portion of the turbomachine.

8. A system according to claim 7, additionally comprising a heat recovery steam generator (HRSG) installed downstream of an exhaust portion downstream of the turbomachine and upstream of the scrubber; wherein the exhaust stream flows from the exhaust portion of the turbomachine to an inlet portion of the HRSG and then flows from an outlet portion of the HRSG to an inlet portion of the scrubber.

9. A system according to claim 7, wherein the compounds comprise at least one of water, acid, aldehydes, hydrocarbons, and combinations thereof.

10. A system according to claim 7, wherein the exhaust stream has a flow rate of approximately 10,000 pounds per hour (lb/hr) to approximately 50,000,000 lb/hr and a temperature of approximately 100° Celsius (C) to about 1,500° C.

11. A method comprising:
utilizing a sulfur compound reduction (SR) system to reduce sulfur compounds of a fuel entering a combustion system prior to burning the fuel; and
burning the fuel and allowing the burned fuel having the sulfur compounds at a reduced level to exit the combustion system for delivery to the turbomachine.

12. A method according to claim 11, wherein the SR system comprises at least one component selected from the group consisting of pressure swing adsorption unit, an iron sponge, a carbon adsorption bed, and a triazine based sulfur compound scavenging unit.

13. A method according to claim 11, wherein the sulfur compounds comprise at least one compound selected from the group consisting of a sulfide, a mercaptan, a thiol, and combinations thereof.

14. A method according to claim 13, wherein the sulfur compounds comprise at least one compound selected from the group consisting of hydrogen sulfide, methyl ethyl sulfide, t-butyl mercaptan, ethyl mercaptan, methyl mercaptan, and combinations thereof.

15. A method according to claim 1, wherein the SR system additionally comprises a fuel line, wherein the fuel line integrates the SR system with the combustion system, allowing for the combustion system to receive the fuel exiting the SR system.
